(19) United States
(12) Patent Application Publication
(10) Pub. No.: US 2015/0280439 A1
(43) Pub. Date: Oct. 1, 2015

(54) APPARATUS FOR GROUNDING INTERCONNECTED ELECTRICAL COMPONENTS AND ASSEMBLIES

(71) Applicant: Enphase Energy, Inc., Petaluma, CA (US)

(72) Inventors: Eric K. Zimmerman, Sebastopol, CA (US); John Scott Berdner, Grass Valley, CA (US); Mark Baldassari, Santa Rosa, CA (US)

(21) Appl. No.: 14/669,084

(22) Filed: Mar. 26, 2015

Related U.S. Application Data
(60) Provisional application No. 61/970,654, filed on Mar. 26, 2014.

(51) Int. Cl. H02J 3/38; H02M 7/44

(52) U.S. Cl. CPC H02J 3/383; H02M 7/44

(57) ABSTRACT

A grounded distributed generator system comprises a plurality of photovoltaic (PV) modules, a plurality of power converters wherein each power converter is electrically coupled to a corresponding one of the PV modules, a cable for electrically coupling at least some of the plurality of power converters to a power line, wherein the cable comprises a ground wire for coupling to ground; and a grounding assembly for electrically coupling the ground wire to at least one exposed metal surface of the distributed generator system.

### REFERENCE TO RELATED APPLICATIONS

This application claims the benefit of priority to U.S. Provisional Patent Application Ser. No. 61/970,654 filed on Mar. 26, 2014 and entitled “ETD Used For Grounding BOS Equipment”, incorporated in its entirety herein by reference.

### BACKGROUND OF THE INVENTION

1. Field of the Invention

Embodiments of the present disclosure relate generally to distributed generator systems, and, in particular, to equipment grounding in photovoltaic systems.

2. Description of the Related Art

Distributed generator (DG) systems, such as photovoltaic (PV) systems, are continuing to come into wider use. As the solar PV supply market continues to mature, the market's focus is expanding beyond the PV module and onto reducing the costs associated with PV balance-of-system (BOS) components. This focus includes all non-module components (inverters, mounting structures, wiring structures, and the like), along with the “soft” costs (such as labor) associated with project development and construction.

One cost associated with PV BOS components is the cost of grounding such components during installation of a PV system. Since PV systems are electrically connected to hazardous voltages and currents, PV systems must be installed to meet relevant requirements for equipment grounding.

Therefore, there is a need in the art for a method and apparatus for efficiently grounding equipment within a distributed generator system.

### SUMMARY OF THE INVENTION

Embodiments of the present invention generally relate to a method and apparatus for equipment grounding in a distributed generator system as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram of photovoltaic energy system in accordance with one or more embodiments consistent with the claimed invention;

FIG. 2 depicts an assembly for grounding BOS equipment in accordance with one or more embodiments consistent with the claimed invention;

FIG. 3 depicts an exploded, perspective view of the assembly of FIG. 2 in accordance with one or more embodiments consistent with the claimed invention;

FIG. 4A is an end view depicting a component of the assembly of FIGS. 2 and 3, a purpose of the depicted component being to guide the terminal ends of one or more conductors within a trunk cable so as to isolate the ground conductor of the trunk cable, according to one or more embodiments consistent with the claimed invention;

FIG. 4B is a side view of the component depicted in FIG. 4A, showing in greater detail the routing of trunk conductors be terminated and/or grounded, according to one or more embodiments consistent with the claimed invention;

FIG. 4C is a side view of a component of the assembly of FIGS. 2 and 3, a purpose of the depicted component being to facilitate an interconnection between an isolated trunk cable ground conductor and one or more electrically coupled modules to be grounded, according to one or more embodiments consistent with the claimed invention;

FIG. 5 depicts an exploded perspective view of an assembly for grounding BOS equipment configured for attachment to an unutilized splice box, according to one or more embodiments consistent with the claimed invention;

FIG. 6 depicts a top view of a junction box used to terminate the distal end of a trunk cable within a wiring system grounded according to one or more embodiments consistent with the claimed invention;

FIGS. 7A to 7G depict various structures for providing an equipment grounding connection in according with one or more embodiments consistent with the claimed invention, the structures defining a stirrup configuration in which a threaded element is turned to urge the portion of an uninsulated ground wire passing through a cavity into electrically conductive contact with the structure defining the cavity;

FIGS. 8A to 8D depict various structures for providing an equipment grounding connection in according with one or more embodiments consistent with the claimed invention, the structures defining a screw terminal configuration in which a threaded element is turned to urge an anti-spread device against an uninsulated ground wire supported by the surface of a fixed, electrically conductive part; and

FIGS. 9A and 9B depict various structures for providing an equipment grounding connection in according with one or more embodiments consistent with the claimed invention, the structures defining a stud terminal configuration.

### DETAILED DESCRIPTION

Embodiments of the present invention generally relate to a method and apparatus for grounding interconnected electrical components and/or assemblies of as shown in and/or described in connection with at least one of the figures, as set forth more completely in the claims.

In an embodiment, a grounded distributed generator system comprises a plurality of photovoltaic (PV) modules, a plurality of power converters wherein each power converter is electrically coupled to a corresponding one of the PV modules, a cable for electrically coupling at least some of the plurality of power converters to a power line, wherein the cable comprises a ground wire for coupling to ground; and a grounding assembly for electrically coupling the ground wire to at least one exposed metal surface of the distributed generator system.

In one or more embodiments, an apparatus for grounding components of a distributed generator system comprises a cable for electrically coupling a plurality of power converters to a power line, wherein each power converter of the plurality of power converters is coupled to a respective photovoltaic (PV) module of a plurality of a plurality of PV modules, and wherein the cable comprises a ground wire for coupling to ground; and a grounding assembly for electrically coupling the ground wire to at least one exposed metal surface of the distributed generator system.

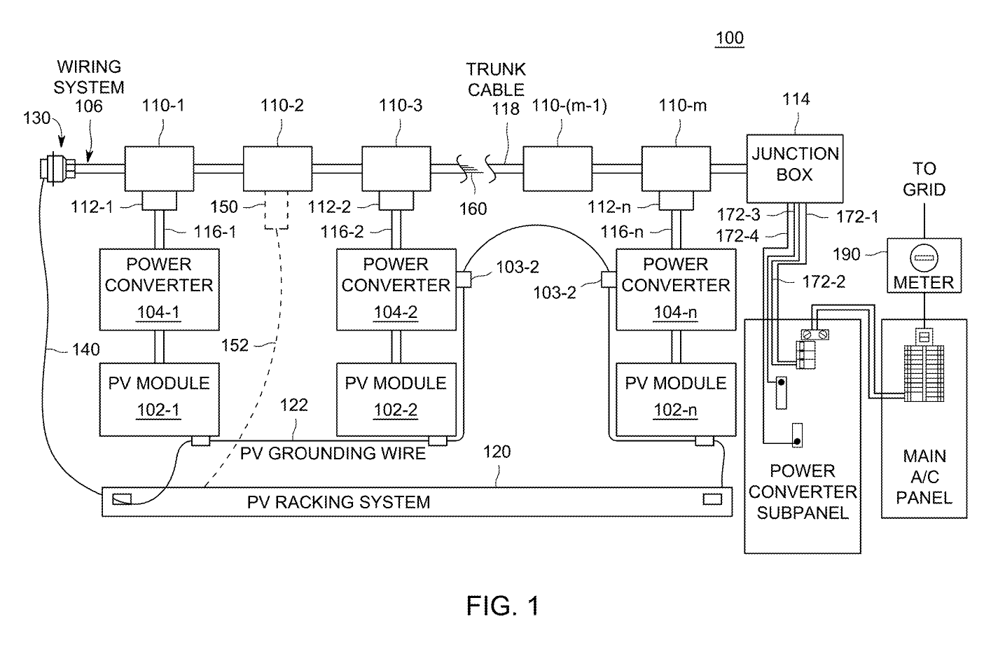

FIG. 1 is a block diagram of a photovoltaic energy system 100 in accordance with one or more embodiments of the present invention. This diagram only portrays one variation of the myriad of possible system configurations. The present invention can function in a variety of power generation environments and systems.

The system 100 comprises a plurality of photovoltaic (PV) modules 102-1, 102-2 . . . 102-N (collectively referred to as PV modules 102), a plurality of power converters 104-1, 104-2 . . . 104-N (collectively referred to as power converters 104), a wiring system 106, a PV racking system 120, and a junction box 114. Each of the PV modules 102 is coupled to an individual power converter 104 in a one-to-one correspondence, although in other embodiments multiple PV modules may be coupled to each power converter 104. The power converters 104 are DC-AC inverters that convert the DC power from the PV modules 102 to AC power; the wiring system 106 carries the generated AC power to the main panel board 114 (which includes circuit breakers coupled to the power lines) and, ultimately, to the AC grid. In other embodiments, the power converters 104 may be DC-DC converters and the wiring system 106 (including a suitable ground conductor) may carry DC energy to a DC-AC inverter at the main panel board 114 (e.g., a plurality of DC-DC boosters coupled to a centralized DC-AC inverter via a wiring system similar to the present disclosure).

The PV modules 102 are coupled to a PV racking system 120 for physically supporting the PV modules 102. The PV modules 102 are electrically coupled to the PV racking system 120 via a PV grounding wire 122. In some embodiments, the power converters 104 may be physically coupled to the PV racking system 120; in other embodiments, the power converters 104 may be physically as well as electrically coupled to the PV modules 102.

The wiring system 106 comprises a cable 118 (trunk cable), a plurality of splice boxes 110-1, 110-2 . . . 110-M (collectively referred to as splice boxes 110) and a termination cap 130 at the distal end of the cable 118. Each of the power converters 104 are coupled to a splice box 110 via a corresponding drop connector 112 and a drop cable 116.

In the depicted embodiment, there are more splice boxes 110 than there are power converters 104 and some splice boxes 110 do not have an inverter coupled to them. In other embodiments, every splice box 110 is connected to a corresponding power converter 104.

The proximal end of the cable 118 is coupled to an alternating current (A/C) junction box 114 which couples the wiring within the cable 118 to a grounded power converter subpanel 170 via wires 172-1, 172-2, 172-3, 172-4. The grounded power converter subpanel 170 is, in turn, connected to the main A/C panel 180 and, via meter 190, to a commercial power supply grid. The cable 118 may comprise five individual wires—three for each phase of a standard three phase system (e.g., 60 Hz or 50 Hz), one for neutral, and one for ground—or fewer individual wires (e.g., three or four wires) for other AC topologies. One example of the wiring system 106 may be found in commonly assigned, U.S. Pat. No. 8,257,106, issued Sep. 4, 2012 and entitled “Method and Apparatus for Interconnecting Distributed Power Sources”, which is herein incorporated by reference in its entirety.

In an embodiment, wires 172-1 and 172-2 are connected to Phases A and B of a commercial power grid via a two pole overcurrent protection device (OCPD) 174 of dedicated power converter subpanel 170. The wire 172-3 is a neutral wire connected to neutral bus bar 176 of the power converter subpanel 170, and the wire 172-4 is a ground wire connected to ground bar 178. Suitable conductors (not shown) may be used to tie the neutral and ground bars 176 and 178 of subpanel 170 to corresponding bus bars (not shown) within main A/C panel 180. An overcurrent protection device (OCPD) 182 may be provided between the subpanel 170 and the main A/C panel 180.

Although the illustrative embodiment depicted in FIG. 1 includes a subpanel 170 useful for aggregating the output of multiple trunk-cable tied power converter modules, it should be readily apparent that the junction box 114 might instead be directly coupled to the main A/C panel 180 via, for example, OCPD 182 and associated ground and neutral bus bars (not shown).

In accordance with one or more embodiments of the present invention, an equipment grounding conductor (EGC) ground for grounding exposed metal surfaces of the PV system (e.g., inverters, mounting structures, wiring structures, and the like, as well as the PV module metal frames) is provided via an existing EGC grounding wire 160 within the cable 118. Representative examples of mounting structures grounded in a manner consistent with the present disclosure include mounting surfaces 103-2. In some embodiments, the termination cap 130 provides a means for coupling an external grounding wire (such as the PV grounding wire 122). In one or more of such embodiments, the termination cap 130 may be formed such that the EGC grounding wire 160 extends through the termination cap 130 and then electrically coupled, in accordance with applicable electrical codes and other regulations, to one or more system components for grounding the components.

Depending on the location and applicable codes, the ground connection(s) using the EGC grounding wire 160 may be obtained via the termination cap 130 using wire connectors such as a screw clamp connection, crimp connectors, exothermic welds, twist-on wire connectors or the like, to the PV grounding wire 122 (as depicted by connection 140) or to another metal element of the system 100 for grounding the element. In some embodiments, the termination cap 130 comprises an internal connector for coupling to the EGC grounding wire 160, and an external connector (such as a lay-in lug or other type of wire connector), electrically coupled to the internal connector through the termination cap 130, for coupling to the PV grounding wire 122 to the EGC grounding wire 160 (as depicted by connection 140) or to another metal element of the system 100. In each of the aforementioned embodiments, the termination cap 130 is IP67 rated (as defined by International Electro-technical Commission (IEC) 60529) and provides protection against elements such as moisture, dust, and the like.

In still other embodiments, a connector 150 may be coupled to an available splice box 110 (e.g., splice box 110-2) for coupling one or more metal components to the EGC grounding wire 160. In some such embodiments, the connector 150 may provide a ground output only, with the ground output being coupled to the EGC grounding wire 160 within the cable 118 when the connector 150 is connected to the splice box 110. The ground output may then be coupled, for example using wire connectors such as a screw clamp connection, crimp connectors, exothermic welds, twist-on wire connectors or the like, to the PV grounding wire 122 (as depicted by connection 152) or to another metal element of the system 100 for grounding the element. In other embodiments, the connector 150 comprises an external connector (such as a lay-in lug or other type of wire connector) that is electrically coupled to the EGC grounding wire 160 within the cable 118 when the connector 150 is connected to the splice box 110. The external connector may then be coupled to the PV grounding wire 122 (as depicted by connection 152) or to another metal element of the system. In each of the aforementioned embodiments, the connector 150 is IP67 rated and provides protection against elements such as moisture, dust, and the like. The connector 150 provides the flexibility to couple the BOS equipment to the EGC grounding wire 160 at any unused splice box 110 as convenient.

By providing a means for grounding metal components of the PV system 100 through the EGC grounding wire 160 of the trunk cable 118, an installer is able to use the ground wire that's already in the home run along with the trunk cable 118 for grounding the BOS equipment in a PV system. As such, installation costs can be reduced and the efficiency of installing such systems increased. Although the grounding for a PV system is described herein, the present invention may be employed in other types of DG systems, such as wind farms, hydroelectric systems, and the like.

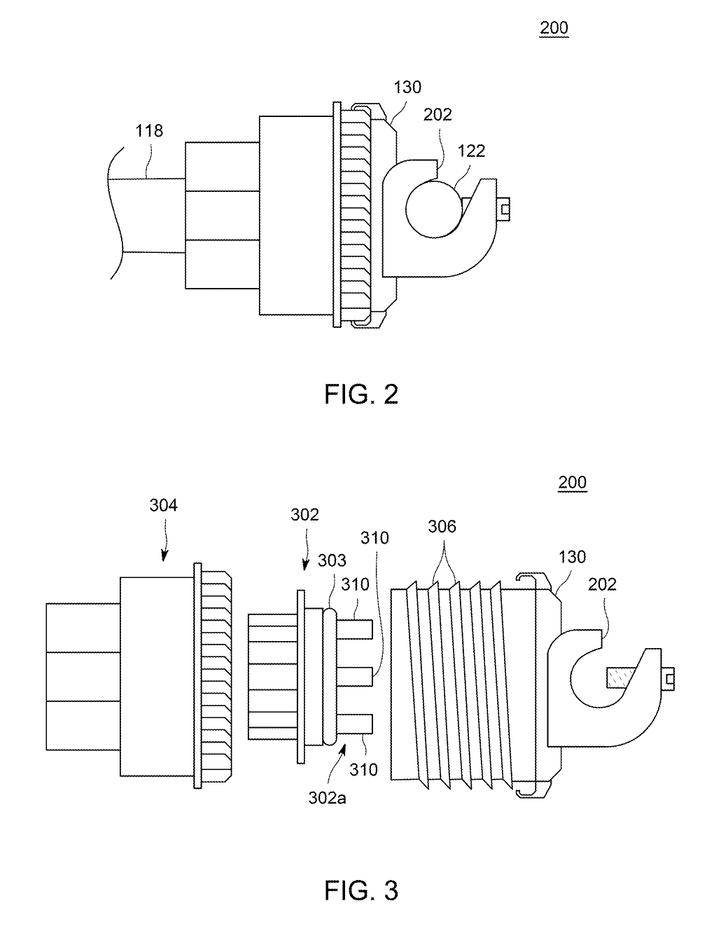

FIG. 2 depicts an assembly 200 for grounding BOS equipment in accordance with one or more embodiments of the present invention. The assembly 200 comprises the cable 118 coupled to the termination cap 130. A lay-in lug 202 is coupled to the exterior of the termination cap 130 and is further electrically connected (through the termination cap 130) to the EGC grounding wire 160 (shown in FIG. 1) within the cable 118. In some embodiments, the interior of the termination cap 130 comprises a metal component (e.g., molded into the termination cap 130) that extends within the termination cap 130 to connect to the EGC grounding wire 160 and is further electrically connected through the termination cap 130 to the lay-in lug 202. For example, a clamp (such as a lay-in lug) or other type of wire connector may extend into the interior of the termination cap 130, where it is coupled to the EGC grounding wire 160, and be further electrically coupled to the exterior lay-in lug 202 through the termination cap 130.

The PV grounding wire 122 (or, alternatively, a grounding wire electrically coupled to one or more other metal components of the system 100) is coupled to the lay-in lug 202 and thus is electrically coupled to the EGC grounding wire 160 through the termination cap 130. Although lay-in lug 202 is depicted in FIG. 2, any other suitable type of wire connector may be employed, such as another type of clamp. The PV grounding wire gauge is generally 6 AWG, although any suitably sized grounding wire may be used, such as wire gauges from 4 AWG-14 AWG.

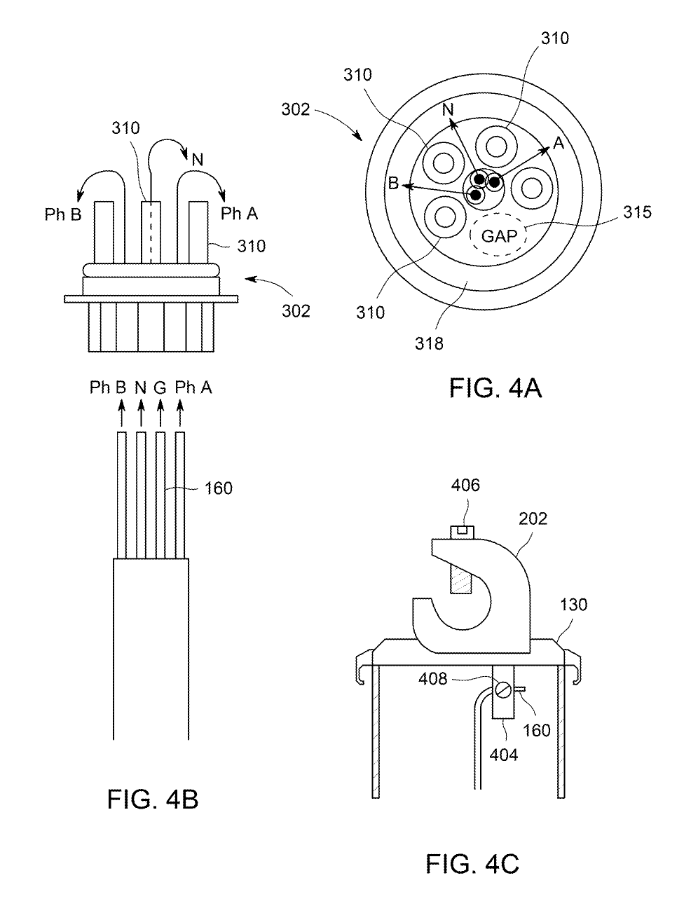

FIG. 3 depicts an exploded, perspective view of the exemplary assembly 200 of FIG. 2 in accordance with one or more embodiments of the present invention. The assembly 200 comprises the termination cap 130, and the lay-in lug 202 (as described above with respect to FIG. 2). The assembly 200 further comprises a second component, indicated generally at reference numeral 302, which slides down the jacket of the cable 118 and provides a weather-tight seal against the jacket of the cable 118 (i.e., on the cable-side of the connection), as well as a keeper indicated generally at reference numeral 304. The termination cap 130 defines an interior cavity dimensioned and arranged to receive component 302 in, for example, a friction fitting manner. In the embodiment of FIGS. 2 and 3, an O-ring 303 of elastomeric material positioned around component 302 provides a weather tight seal for an enclosure formed between the outer surface of component 302, and the interior surface of termination cap 130. This weather tight enclosure provides a corrosion resistant environment for the connection of the EGC ground wire 160 within cable 118 to lay-in lug 202.

Keeper 304 also has an axial bore extending through it, the interior surface of the bore within keeper 304 being dimensioned and arranged to allow insertion of the end of the trunk cable 118 so that the keeper 304 is situated adjacent to where the grounding connection is to be performed. In some embodiments, the interior surface of keeper 304 is threaded for mating engagement with termination cap 130. Other configurations for releasably locking the keeper 304 and termination cap 130 together may also be used. Placement of the keeper 304 precedes the placement of the component 302 onto the cable 118.

Once the end of the cable 118 passes through the keeper 304, component 302 is slid on as well and the terminal ends of all conductors but the ground conductor are terminated as, for example, by bending them around the exterior surface of component 302. To aid in this operation, a plurality of radially arranged wire guides 310 are provided, the guides 310 being spaced apart such that adjacent guides 310 form a respective gap. Each gap is dimensioned and arranged to enable a corresponding conductor emerging from the axial bore within component 302 to pass through, out and around. These conductors are then cut to a length short enough so that they are retained between the adjacent supports and that they are retained within the weather-tight volume formed between the outer surface of component 302 and the interior surface of termination cap 130.

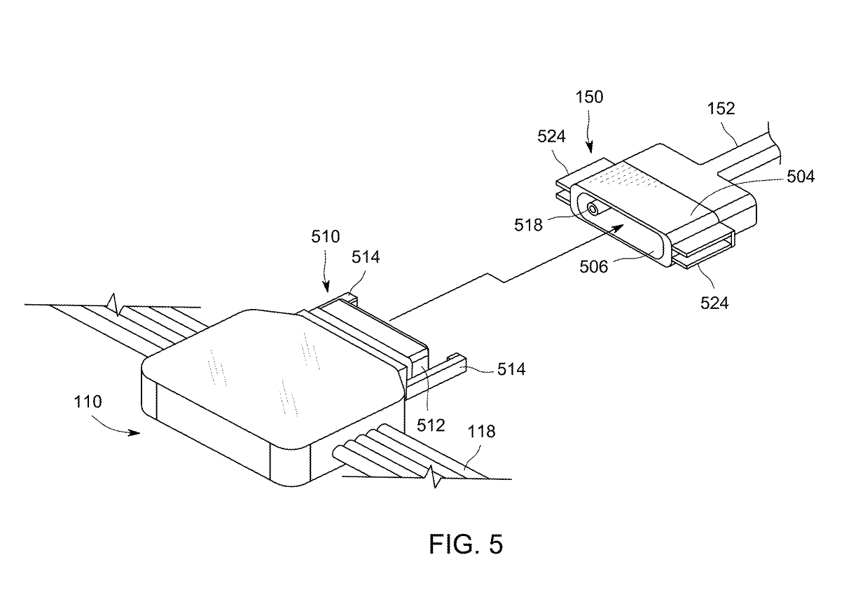

FIG. 4A is an end view depicting in greater detail the component 302 of the assembly 200 of FIG. 3, a purpose of the depicted component 302 being to guide the terminal ends of one or more conductors within a trunk cable (i.e., the trunk cable 116) so as to isolate the ground conductor (i.e., the grounding wire 160) of the trunk cable, according to one or more embodiments consistent with the claimed invention. It should be noted that although an arrangement of four conductors (i.e., phases A and B, as well as a neutral wire N and ground wire G) are depicted in FIG. 4A and/or FIG. 4B, a larger (or smaller) number of conductors may be utilized. For example, in a three phase system, and additional wire corresponding to phase C (not shown) may be included. Likewise, the wire A or B corresponding to either of phase A or phase B may be omitted in a single phase system. In any of the aforementioned configurations, the neutral wire N may also be omitted.

The direction of the arrows show the path for manipulating the power (e.g., Ph A, Ph B) and neutral N conductors of cable 118. It will be noted that a gap 315 exists on the surface 316 of component 302. In an embodiment, gap 315 is dimensioned and arranged to receive a ground terminal 404 (FIG. 4C) of termination cap 130. In an embodiment, the surface 318 is dimensioned and arranged to receive and support an elastomeric sealing member such as gasket or O-ring 303 shown in FIG. 3. Sealing member 303, as noted previously enables a corrosion resistant interconnection between the ground wire (i.e., the EGC grounding wire 160) of trunk 118 and the lay-in lug 202 (FIG. 2, 3 or 4C).

FIG. 4B is a side view of the component 302 depicted in FIG. 4A, showing in greater detail the routing of trunk conductors of cable 118 to be terminated and/or grounded, according to one or more embodiments consistent with the claimed invention. FIG. 4C is a side view of a component of the assembly of FIGS. 2 and 3. As seen in FIG. 4C, the lay-in lug 202 of termination cap 130 forms part of an interconnected assembly with a ground terminal 404. In the embodiment of FIG. 4C, the ground terminal 404 is of the screw-type and includes a threaded screw 408 which urges the ground connector G from cable 118 into contact with a fixed metal contact (not shown).

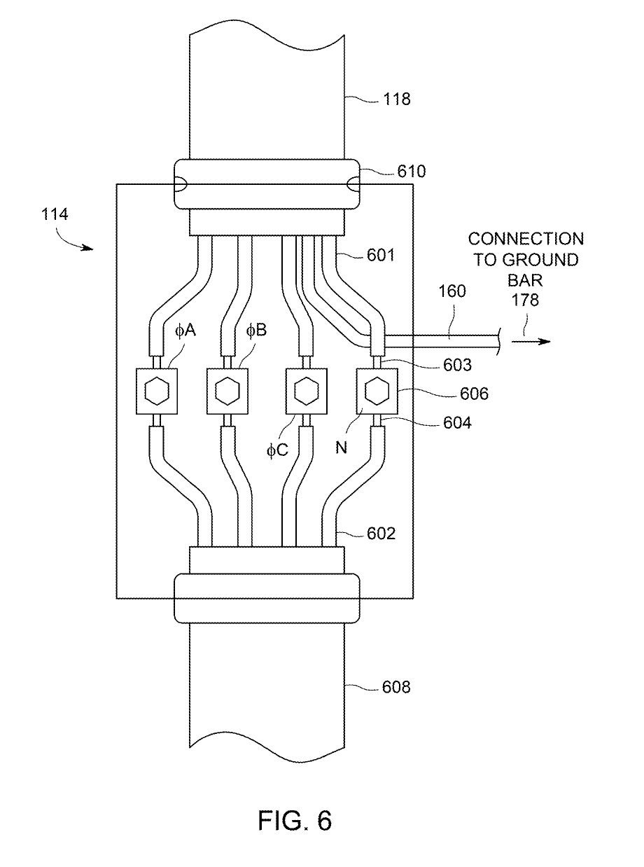

FIG. 5 depicts an exploded perspective view of an assembly 500 configured for attachment to an unutilized splice box 110 for grounding BOS equipment, according to one or more embodiments consistent with the present disclosure. In one or more embodiments, a ground connector (e.g. ground connector 150) is adapted—via a “spare” splice box, as for example splice box 110-2 of FIG. 1—to provide the necessary ground interconnection to the PV racking system 120 and PV grounding wire 122 for grounding BOS components. For example, and as optionally depicted in FIG. 1, a ground connector 150 may be used to make the connection between a ground conductor 152 and the PV racking system 120.

The splice box 110 is part of a standard cable used to connect inverters to a grid. A typical splice box, as splice box 110-2, has pins that are respectively connected to the ground wire, neutral wire, and one or more current carrying wires of cable 118 that correspond to phases matched to the grid. For purposes of the present disclosure, the connector 150 need only include a ground output only (e.g., only a single plug pin receptacle 518 which connects to the ground pin in splice box 110). Alternatively, the connector may be configured with a separate plug pin receptacle for each of the aforementioned ground, neutral and current carrying pins of the splice box, with only the ground pin receptacle having a wire through 152.

In the embodiment of FIG. 5, ground connector 150 includes a socket 504 within which a ground socket plug pin receptacle 518 is disposed, while splice box 110 includes a plug assembly 510 including a plug 512 within which a plug pin (not shown) extends. The plug 512 is dimensioned and arranged for insertion into a cavity 506 defined by socket 504, the pin and receptacle 518 being in electrically and mechanically mating registration when respective plug latches 514 are received within corresponding socket latches 524. When mated in this fashion, the ground socket pin receptacle 518 is electrically and mechanically coupled to the EGC grounding wire 160 within cable 118 as well as to the grounding conductor within cable 152.

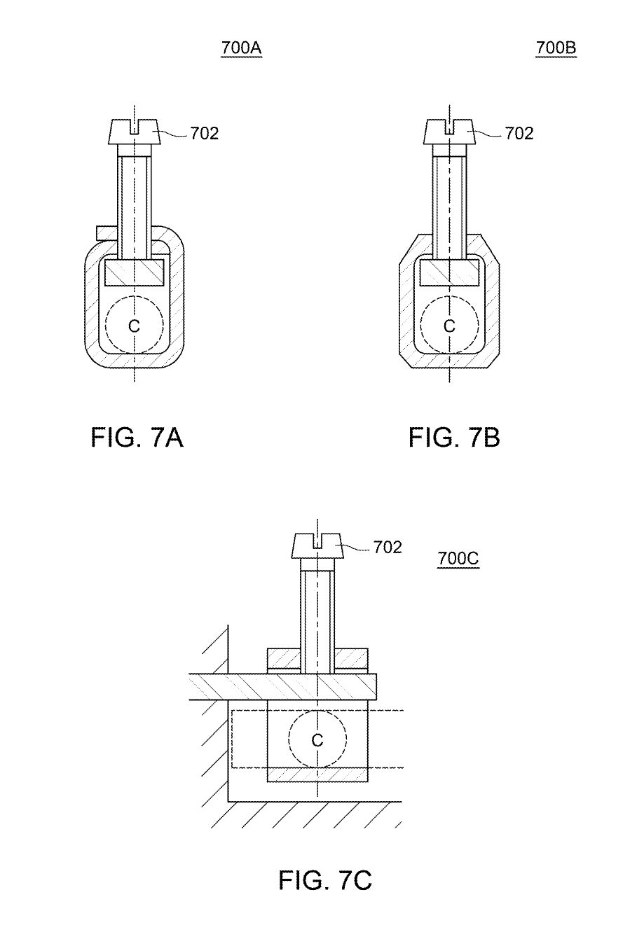

FIG. 6 depicts a top view of a junction box 114 for coupling the wiring system 106 (FIG. 1) to a commercial power grid in accordance with one or more embodiments consistent with the present disclosure. The junction box 114 provides an environmentally protected connection between the cable wires 601 of the wiring system 106 and conduit wires 602 that are electrically coupled to the AC power grid via subpanel 170, main panel 180, and meter 190 (FIG. 1). The proximal end of the cable 118 extends through one side of the junction box 114. The insulation of the cable 118 is stripped to expose the cable wires 601 corresponding, in a three-phase example, to phases A, B, and C and to a neutral wire N. Ground wire 160 of cable 118 is connected to ground bar 178 (FIG. 1).

The insulation at the ends of the cable wires 601 is stripped to expose the wire conductors 603. Similarly, the insulation from the ends of each conduit wire 602 is stripped to expose conduit wire conductors 604. The conductors 603 and 604 exposed at the stripped ends of the wires 601 and 602, respectively, are electrically connected to one another using twist-on wire connectors 606 (i.e., one twist-on wire connector for each cable wire/conduit wire) or some other means for connecting the wire conductors to one another. In this manner, the AC power generated by the power converters 104 and PV modules 102 is coupled to the power grid. A cover (not shown) is placed over the junction box 114 to protect the exposed wires from the environment.

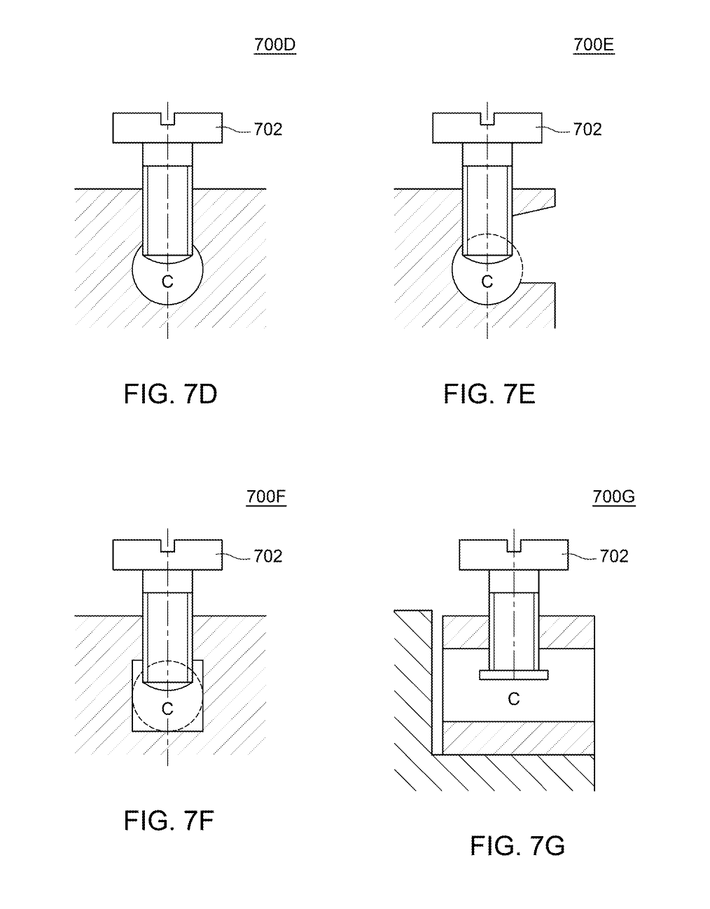

The manner in which the PV grounding wire 122 may be interconnected to the lay-in lug 202 (FIG. 2) admits of substantial variation. FIGS. 7A through 9B depict a number of non-limiting examples. FIGS. 7A to 7G, for example, depict various structures 700A to 700G for providing an equipment grounding connection. According to one or more embodiments consistent with the claimed invention, the structures defining a stirrup configuration in which a threaded element 702 is turned to urge the portion of an uninsulated ground wire (e.g., PV grounding wire 122) passing through a cavity C into electrically conductive contact with the structure defining the cavity.

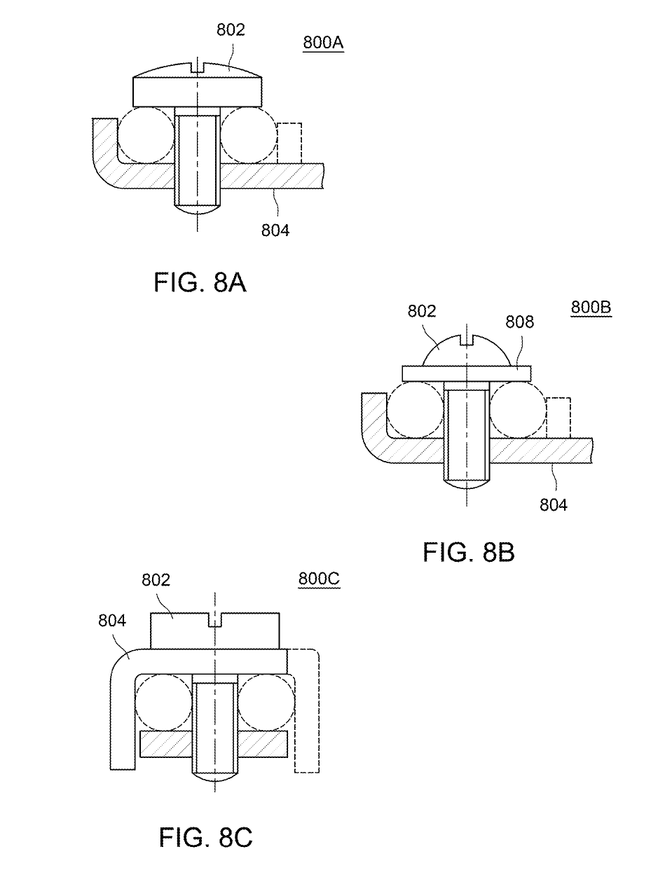

FIGS. 8A to 8D depict various structures 800 for providing an equipment grounding connection in accordance with one or more embodiments consistent with the present disclosure, the structures defining a screw terminal configuration in which a threaded element (e.g., a screw) 802 is turned to urge an uninsulated ground wire (e.g., PV grounding wire 122) against a fixed, electrically conductive part 804. FIGS. 8A and 8C depict structures which do not require the inclusion of a washer 808 (as shown in FIG. 8B), or an anti-spread device 808 (as shown in FIG. 8D).

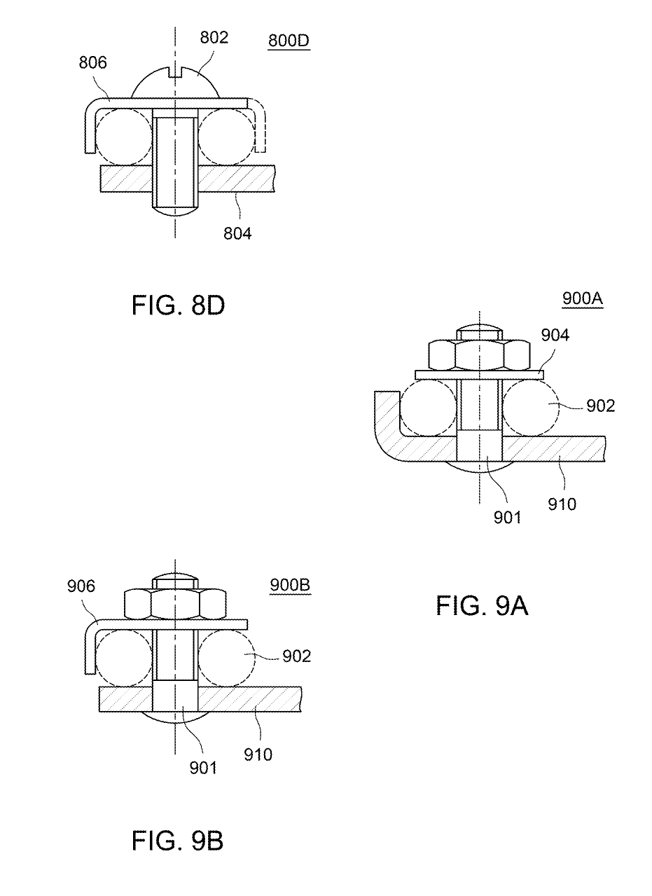

FIGS. 9A and 9B depict various structures 900A or 900B for providing an equipment grounding connection in accordance with one or more embodiments consistent with the present disclosure, the structures defining a stud terminal configuration. In such embodiments, a threaded stud 901 is used in conjunction with a washer 904 (FIG. 9A) or anti-spread device 906 (FIG. 9B) to bring the conductor 902 into contact with the fixed conductor element 910. The area over which the clamping force is exerted by the washer or anti-spread device is measured across the dimension D.

While the foregoing is directed to embodiments of the present invention, other and further embodiments of the invention may be devised without departing from the basic scope thereof, as defined by the annexed claims.

What is claimed is:

1. An apparatus for grounding components of a distributed generator system, comprising:
a cable for electrically coupling a plurality of power converters to a power line, wherein each power converter of the plurality of power converters is coupled to a respective photovoltaic (PV) module of a plurality of a plurality of PV modules, and wherein the cable comprises a ground wire for coupling to ground; and
a grounding assembly for electrically coupling the ground wire to at least one exposed metal surface of the distributed generator system.

2. The apparatus of claim 1, wherein the power converters are DC to AC inverters.

3. The apparatus of claim 1, wherein the grounding assembly comprises a first component defining an axial bore dimensioned and arranged to receive a proximal portion of the cable in a friction fitting relation.

4. The apparatus of claim 3, wherein the grounding assembly further comprises a second component defining an axial bore dimensioned and arranged to receive a first end of the first component in a friction fitting relation.

5. The apparatus of claim 4, wherein the second component includes a first ground connector terminal for establishing an electrical connection to the grounding wire of the cable and a second ground connector terminal for establishing an electrical ground connection to at least one exposed metal surface of a component of the distributed generator system.

6. The apparatus of claim 5, wherein the grounding assembly further comprises a keeper positionable over the cable past the proximal portion and dimensioned and arranged to receive a second end of the first component and a first end of the second component.

7. The apparatus of claim 4, wherein the grounding assembly further comprises a keeper positionable over the cable past the proximal portion and dimensioned and arranged to receive a second end of the first component and a first end of the second component.

8. The apparatus of claim 3, wherein the grounding assembly further comprises a keeper positionable over the cable past the proximal portion and dimensioned and arranged to receive a second end of the first component.

9. The apparatus of claim 1, wherein the distributed generator system includes a plurality of splice boxes, and wherein the cable further includes a plurality of conductors, the conductors and ground wire of the cable being electrically coupled to at least some of the splice boxes.

10. The apparatus of claim 9, wherein the grounding assembly comprises at least one of a socket and a plug dimensioned and arranged to establish an electrical connection between the ground wire and at least one exposed metal surface of at least one component of the distributed generator system.

11. The apparatus of claim 10, wherein the grounding assembly further includes a second ground wire for electrically connecting the ground wire of the cable to the at least one metal surface.

12. A grounded distributed generator system, comprising:
a plurality of photovoltaic (PV) modules;
a plurality of power converters, each power converter being electrically coupled to a corresponding one of the PV modules;
a cable for electrically coupling at least some of the plurality of power converters to a power line, wherein the cable comprises a ground wire for coupling to ground; and
a grounding assembly for electrically coupling the ground wire to at least one exposed metal surface of the distributed generator system.

13. The system of claim 12, wherein the power converters are DC to AC inverters.

14. The system of claim 12, wherein the grounding assembly comprises a first component defining an axial bore dimensioned and arranged to receive a proximal portion of the cable in a friction fitting relation.

15. The system of claim 14, wherein the grounding assembly further comprises a second component defining an axial bore dimensioned and arranged to receive a first end of the first component in a friction fitting relation.

16. The apparatus of claim 15, wherein the second component includes a first ground connector terminal for establishing an electrical connection to the grounding wire of the cable and a second ground connector terminal for establishing an electrical ground connection to at least one exposed metal surface of a component of the distributed generator system.

17. The system of claim 15, wherein the grounding assembly further comprises a keeper positionable over the cable past the proximal portion and dimensioned and arranged to receive a second end of the first component and a first end of the second component.

18. The system of claim 1, wherein the distributed generator system includes a plurality of splice boxes, and wherein the cable further includes a plurality of conductors, the conductors and ground wire of the cable being electrically coupled to at least some of the splice boxes.

19. The system of claim 18, wherein the grounding assembly comprises at least one of a socket and a plug dimensioned and arranged to establish an electrical connection between the ground wire and at least one exposed metal surface of at least one component of the distributed generator system.

20. The system of 19, wherein the grounding assembly further includes a second ground wire for electrically connecting the ground wire of the cable to the at least one metal surface.
